(19) United States
(12) Patent Application Publication
(10) Pub. No.: US 2006/0235169 A1
(43) Pub. Date: Oct. 19, 2006

(54) Composition containing polyaniline compound

(76) Inventor: Hayahide Yamasaki, Kyoto (JP)

Correspondence Address: WENDEROTH, LIND & PONACK, L.L.P., 2033 K STREET N. W., SUITE 800, WASHINGTON, DC, 20006-1021, US

(21) Appl. No.: 10/553,265

(22) PCT Filed: Apr. 7, 2004
(86) PCT No.: PCT/JP04/04998

§ 371 Date: Dec. 1, 2005

(30) Foreign Application Priority Data
Apr. 11, 2003 (JP) 2003107988
Apr. 14, 2003 (JP) 2003108607

(51) Int. Cl. C08L 79/00; C08G 73/00

(52) U.S. Cl. 525/540

(57) ABSTRACT

Provided is a polyaniline-containing composition wherein a polyaniline is uniformly dispersed in water or a water-soluble solvent that gives a coated film higher in conductivity and superior in water resistence, strength, and flexibility as it is coated, characterized by containing a polyaniline and an emulsion polymer, wherein the emulsion polymer includes a vinylpyrrolidone and an acid group-containing monomer as constituent monomers and as essential components.

### FIELD OF THE INVENTION

The present invention relates to a polyaniline-containing composition wherein the polyaniline is dispersed uniformly in water or a water-soluble solvent.

### BACKGROUND OF THE INVENTION

Among various conductive polymers, a polyaniline, which is favorable in the stability in air, has been studied for application in various fields. Typical examples of the applications thereof include a cathode for secondary battery, a solid electrolyte capacitor, an antistatic agent, an antirust agent, a transparent conductive film, an electromagnetic wave-shielding material, and the like.

In most of these applications, a polyaniline is coated on various materials for use. Properties demanded for the coated films in such a case include the forming property as well as the strength and flexibility of the coated films, in addition to conductivity, a property inherent to the polyaniline.

However, a polyaniline is generally, extremely lower in the solubility or the dispersibility in water or a water-soluble solvent and thus, gives only a film lower in polyaniline content and unsatisfactory in conductivity when used as a coating agent. Even when dispersed forcibly, polyaniline caused a problem that it was difficult to prepare a uniformly coated film because of its poor dispersion state and the coated film thus obtained was insufficient in strength and flexibility.

To overcome these problem, proposed are, for example, a method (1) of preparing a polyaniline-containing composition superior in dispersion by oxidative polymerizing of aniline monomers in the presence of an emulsion polymer (JP-A No. 64-69621 and others) and a method (2) of mixing a polyaniline in the doped state with an emulsion polymer (JP-A No. 64-69621 and others).

However, in these methods, the oxidative polymerization reaction of anilines in the presence of a polymer emulsion is very slow, giving only a polyaniline lower in molecular weight and thus, often gives a coated film insufficient in conductivity. In addition, it is necessary to add a large amount of a dopant for production of a polyaniline in the doped state that forms a stable liquid mixture with the polymer emulsion, which results in the problem of deterioration in the water resistence of the coated film obtained from the polyaniline-containing composition.

It is an object of the present invention to provide a polyaniline-containing composition that includes polyaniline uniformly dispersed in water or a water-soluble solvent and gives a coated film higher in conductivity and superior both in water resistence and strength/flexibility when coated.

### DISCLOSURE OF THE INVENTION

The polyaniline-containing composition according to the present invention is characterized by comprising a polyaniline and an emulsion polymer, wherein the emulsion polymer includes a vinylpyrrolidone and an acid group-containing monomer as constituent monomers and as essential components.

The polyaniline-containing composition containing the vinylpyrrolidone at a rate in the range of 10 to 90% by mass in the constituent monomers, which is particularly superior in dispersibility of the polyaniline and gives a coated film higher in high conductivity, is a preferable embodiment of the present invention.

### BEST MODE FOR CARRYING OUT THE INVENTION

The inventors have studied intensively on polyaniline-containing compositions wherein a polyaniline is dispersed in water or a water-soluble solvent. As a result, the inventors have found that it was possible to obtain a composition including a polyaniline and an emulsion polymer wherein the polyaniline is dispersed uniformly by adding a vinylpyrrolidone and an acid group-containing monomer as essential components in the constituent monomers for the emulsion polymer, to obtain a coated film higher in conductivity and superior in water resistence, strength and flexibility by coating the composition, and thus to overcome the problem above.

A common emeraldine-type polyaniline is used favorably as the polyaniline according to the present invention. The emeraldine-type polyaniline is a resin including a basic skeleton having a reduced form unit (phenylenediamine skeleton) and an oxidized form unit (quinonimine skeleton) at a molar ratio of 1:1 as a recurring unit.

The polyaniline for use in the present invention may be a resin prepared by any known method or a product commercially available as it is.

In addition to the emeraldine-type polyanilines, a polyaniline having an o- or m-substituted aromatic ring in a polyaniline skeleton may be used as the polyaniline. Examples of the substituent groups include an alkyl group having a carbon number of 1 to 20, an alkoxyl group having a carbon number of 1 to 20, a carboxyl ester group having a carbon number of 1 to 20, a cyano group, an aryl group, a sulfone group, a halogen group, and the like.

The polyaniline preferably has a weight-average molecular weight (Mw) of 2,000 or more as polyethylene oxide as determined by GPC. A polyaniline having a weight-average molecular weight of less than 2,000 may lead to deterioration in the conductivity of the coated film obtained from the polyaniline-containing composition. On the other hand, a polyaniline having a weight-average molecular weight of more than 300,000 may result in poor dispersion of the polyaniline and deterioration in the strength and the flexibility of the coated film. The weight-average molecular weight is more preferably in the range of 3,000 to 200,000, and still more preferably 5,000 to 100,000.

The content of the polyaniline in the polyaniline-containing composition according to the present invention is preferably in the range of 0.02 to 10% by mass in the composition. The content of less than 0.02% by mass tends to result in deterioration in the conductivity of the coated film obtained from the polyaniline-containing composition, while the content of more than 10% by mass may result in poor dispersion of the polyaniline and deterioration in the strength and the flexibility of the coated film obtained from the polyaniline-containing composition. The content is more preferably in the range of 0.1 to 8% by mass, and most preferably 0.5 to 6% by mass.

The content of the emulsion polymer in the polyaniline-containing composition according to the present invention is preferably in the range of 10 to 60% by mass in the composition. The content of less than 10% by mass may lead to deterioration in the film-forming property of the polyaniline-containing composition, and therefore a uniformly coated film can not be formed, while the content of more than 60% by mass may lead to increase in the viscosity of the polyaniline-containing composition, resulting in decrease in handling processability. The content is more preferable in the range of 15 to 50% by mass and most preferably 20 to 40% by mass.

The emulsion polymer according to the present invention includes a vinylpyrrolidone and an acid group-containing monomer as constituent monomers and as essential components.

The vinylpyrrolidones include, for example, N-vinylpyrrolidone, N-vinyl-5-methyl-2-pyrrolidone, and the like.

The amount of the vinylpyrrolidone used in the constituent monomers is preferably in the range of 10 to 70% by mass. The used amount of less than 10% by mass may lead to poor dispersion of the polyaniline, while the used amount of more than 70% by mass may lead to deterioration in the water resistence of the coated film obtained from the polyaniline-containing composition. The amount is more preferably in the range of 15 to 50% by mass, and most preferably 20 to 40% by mass.

The acid group-containing monomer used in combination with the vinylpyrrolidone in the present invention functions as a dopant for giving the polyaniline conductivity as it is doped. Preferable examples of the acid group-containing monomers include carboxyl group-containing monomers, sulfone group-containing monomers, and phosphoric acid group-containing monomers; and specific examples thereof include (meth)acrylic acid, 2-acrylamido-2-methylpropanesulfonic acid, methacrylsulfonic acid, 3-sulfopropyl (meth)acrylate, 2-(meth)acryloyloxyethyl acid phosphate, and the like.

The preferable lower limit value of the amount of the acid group-containing monomer in the constituent monomers for the emulsion polymer for use in the present invention is 0.1% by mass, and the preferable upper limit thereof 40% by mass. The used amount of less than 0.1% by mass may lead to decrease in the efficiency of doping polyaniline and thus insufficient conductivity of the coated film obtained from the polyaniline-containing composition, while the used amount of more than 40% by mass may lead to deterioration in the water resistence of the coated film obtained from the polyaniline-containing composition. The lower limit value of the used amount is more preferably 0.5% by mass, and most preferably 1.0% by mass or more. The upper limit value of the used amount is more preferably 30% by mass, and most preferably 20% by mass or less.

The emulsion polymer may contain monomers other than the vinylpyrrolidone and the acid group-containing monomer as constituent monomers. The kinds and the amounts of other monomers are selected properly according to the physical properties desirable for the coated film obtained from the polyaniline-containing composition.

Examples of the other monomers include (meth)acrylates such as methyl (meth)acrylate, ethyl (meth)acrylate, butyl (meth)acrylate, 2-ethylhexyl (meth)acrylate, lauryl (meth)acrylate, propyl (meth)acrylate, cyclohexyl (meth)acrylate, isobornyl (meth)acrylate, dicyclopentenyloxyethyl (meth)acrylate, methoxydiethylene glycol (meth)acrylate, phenoxyethyl (meth)acrylate, 2-hydroxyethyl (meth)acrylate, hydroxypropyl (meth)acrylate, hydroxybutyl (meth)acrylate, ethylene glycol di(meth)acrylate, diethylene glycol di(meth)acrylate, triethylene glycol di(meth)acrylate, propylene glycol di(meth)acrylate, dipropylene glycol di(meth)acrylate, and 1,6-hexanediol di(meth)acrylate; (meta)acrylamide, methylene bis(meta)acrylamide, styrene, α-methylstyrene, vinyltoluene, divinylbenzene, and the like.

The amount of the other monomers in the constituent monomers for the emulsion polymer for use in the present invention is preferably in the range of 10 to 80% by mass. The used amount of less than 10% by mass may lead to deterioration in the water resistence of the coated film obtained from the polyaniline-containing composition, while the used amount of more than 80% by mass may lead to poor dispersion of the polyaniline and deterioration in the conductivity of the coated film obtained from the polyaniline-containing composition. The used amount is more preferably in the range of 20 to 70% by mass, and most preferably 30 to 60% by mass.

For production method of the polyaniline-containing composition according to the present invention, preferable is a method of previously dissolving or dispersing a polyaniline in a monomer mixture for emulsion polymerization including a vinylpyrrolidone as an essential monomer component, and then emulsion polymerizing the resulting mixture. It is because it is easier to increase the dispersibility of a polyaniline and thus to prepare a polyaniline-containing composition giving the coated film higher in conductivity by the method.

During solubilization or dispersion of the polyaniline in the monomer mixture for emulsion polymerization including a vinylpyrrolidone as an essential component, use of an undoped polyaniline, i.e., the polyaniline that is not previously doped, as the polyaniline before solubilization or dispersion is preferable for facilitating dispersibility of the polyaniline. That is, the doping occurs when the polyaniline is dissolved or dispersed in the monomer mixture for emulsion polymerization, and the property of the polyaniline changes from electrically insulative to electrically conductive as it is doped.

During the solubilization or dispersion, it is preferable to dissolve or disperse the polyaniline while the mixture is agitated in a device that is capable of high-speed stirring such as a homogenizer or a homomixer.

Any one of common emulsion polymerization methods may be used during the emulsion polymerization for producing the emulsion polymer, and examples thereof include a simultaneous monomer addition, a dropwise monomer addition, a preemulsification, a power feeding, a seed polymerization, a multi-step monomer addition, and the like.

The conditions, for example, temperature and period, of emulsion polymerization reaction may be decided properly. The emulsion polymerization reaction is preferably performed under an inert gas atmosphere such as nitrogen, and a chain transfer agent may be added for making of the adjustment of the average molecular weight of the polymer.

Nonionic emulsifiers capable of keeping micelle more stable are preferable as the emulsifiers for use during the emulsion polymerization, and among them, emulsifiers having an aromatic ring in the molecule skeleton are preferable, because they have a high affinity with a polyaniline.

Typical examples of the emulsifiers include, for example, “Nonipol series” products, “Eleminol SCZ-35”, “Eleminol STN-6”, “Eleminol STN-8”, “Eleminol STN-13”, “Eleminol STN-20”, and “Eleminol STN-45” (trade names, all manufactured by Sanyo Chemical Industries Ltd.); “Emulgen A-60”, “Emulgen A-66”, and “Emulgen A-90” (trade names, all manufactured by Kao Corporation); “Noigen EA-157”, “Noigen EA-167”, “Noigen EA-177”, “Aqualon RN-10”, “Aqualon RN-20”, “Aqualon RN-30”, and “Aqualon RN-50” (trade names, all manufactured by Dai-ichi Kogyo Seiyaku Co., Ltd.); and the like.

The emulsifier preferably has a HLB (abbreviation of Hydrophile-Lipophile Balance) in the range of 12 to 18, from the point of the stability of the micelle.

The amount of the emulsifiers used is preferably in the range of 1 to 15 parts by mass with respect to 100 parts by mass of the monomer mixture. The used amount of less than 1 part by mass may lead to instabilization of the reaction solution during emulsion polymerization, while the used amount of more than 15 parts by mass may lead to insufficient water resistence of the coated film obtained from the polyaniline-containing composition. The amount is more preferably in the range of 3 to 12 parts by mass, and most preferably 5 to 10 parts by mass.

The polymerization initiators used during the emulsion polymerization are preferably an azo-based polymerization initiator, which is less oxidative to polyaniline. Typical examples of the azo-based polymerization initiators include water-soluble azo compounds such as 2,2′-azobis(2-amidinopropane) dihydrochloride and 4,4′-azobis(4-cyanopentanoic acid), and the like.

The amount of the polymerization initiator used is preferably in the range of 0.1 to 5 parts by mass with respect to 100 parts by mass of the monomer mixture. The used amount of less than 0.1 parts by mass may result in slower progress of the emulsion polymerization reaction, leaving more unreacted monomers, and deterioration in the strength and the flexibility of the coated film obtained from the polyaniline-containing composition, while the used amount of more than 5 parts by mass, which is excessively high, may result in deterioration in the stability of the emulsion polymerization. The amount of the polymerization initiator used is more preferably in the range of 0.5 to 3 parts by mass, and most preferably 0.7 to 2 parts by mass.

The polyaniline-containing composition according to the present invention may include other compounds and secondary materials as needed.

Examples of the other compounds and secondary materials include an antioxidant, an ultraviolet absorbent, an ultraviolet stabilizer, a plasticizer, a leveling agent, a repulsion inhibitor, a solvent and the like. The used amount of the other compounds and secondary materials is not particularly limited, if it is in the range that does not impair the advantageous effects of the present invention, but is preferably in the range of 0.001 to 10 parts by mass with respect to 100 parts by mass of the composition.

### EXAMPLES

Hereinafter, the present invention will be described in more detail with reference to Examples, but it should be understood that the present invention is not restricted by the following Examples and can be properly modified within the scope described above or below and such modifications are also included in the technical scope of the present invention. In Examples below, “%” means “% by mass”, and “part” means “part by mass” respectively, unless specified otherwise,

### Example 1

Ten parts of polyaniline (emeraldine-based polyaniline, trade name: “PANIPOL PA”, manufactured by Panipol) as a polyaniline was dissolved uniformly in 20 parts of N-vinylpyrrolidone as a vinylpyrrolidone, to give a blue purple polyaniline solution. The solution was added dropwise into a liquid mixture of 20 parts of styrene, 10 parts of butyl acrylate, and 10 parts of acrylic acid as an acid group-containing monomer, while the mixture was stirred in a homogenizer, to give a dark green mixture solution in which polyaniline was dispersed uniformly.

140 parts of ion-exchange water and 1.8 parts of a surfactant (trade name: “Nonipol 200”, manufactured by Sanyo Chemical Industries Ltd.) were placed in a reactor equipped with a thermometer, a condenser tube, a nitrogen-supply tube, a dropping funnel, and a stirrer, and the mixture was stirred and dissolved under nitrogen gas flow. The liquid mixture above was placed in the dropping funnel, and one tenth of it was added dropwise into the reactor. Then, 12 parts of a 5% aqueous 2,2′-azobis(2-amidinopropane) dihydrochloride salt solution was added, allowing polymerization reaction to proceed at 70° C. for 30 minutes, and then, the remaining liquid mixture was added dropwise over 2 hours. After dropwise addition, the polymerization reaction was continued at the same temperature additionally for 1 hour, to give a polyaniline-containing composition (1) including nonvolatile matters and polyaniline respectively at concentrations of 29% and 4.5%.

### Example 2

Seven parts of polyaniline was dissolved in 5 parts of N-vinylpyrrolidone uniformly, to give a blue purple polyaniline solution. The solution was added dropwise into a liquid mixture containing 20 parts of styrene, 10 parts of butyl acrylate, and 10 parts of acrylic acid while the mixture was stirred in a homogenizer, to give a dark green mixture solution in which polyaniline was dispersed uniformly.

Then, the liquid mixture was allowed to react in the emulsion polymerization reaction in a similar manner to Example 1, to give a polyaniline-containing composition (2) according to the present invention containing nonvolatile matters and polyaniline respectively at concentrations of 25% and 1.0%.

### Example 3

Seven parts of polyaniline was dissolved in 20 parts of N-vinylpyrrolidone uniformly, to give a blue purple polyaniline solution. The solution was added dropwise into a liquid mixture containing 20 parts of styrene, 10 parts of butyl acrylate, and 5 parts of 2-acrylamido-2-methylpropanesulfonic acid as an acid group-containing monomer while the mixture was stirred in a homogenizer, to give a dark green liquid mixture in which polyaniline was dispersed uniformly.

Then, the liquid mixture was allowed to react in the emulsion polymerization reaction in a similar manner to Example 1, to give a polyaniline-containing composition (3) according to the present invention containing nonvolatile matters and polyaniline respectively at concentrations of 30% and 3.2%.

### Comparative Example 1

Ten parts of polyaniline was dissolved in 20 parts of N-vinylpyrrolidone uniformly, to give a blue purple polyaniline solution. The solution was added dropwise into a liquid mixture of 20 parts of styrene and 10 parts of butyl acrylate while the mixture was stirred in a homogenizer, to give a blue purple liquid mixture in which polyaniline was dispersed uniformly. In this Example in which no acid group-containing monomer was used as the monomer, the polyaniline was not doped and thus still electrically insulative.

The monomer mixture was allowed in the emulsion polymerization reactionin a similar manner to Example 1, to give an extremely unstable polyaniline-containing composition (1) containing nonvolatile matters and polyaniline respectively at concentrations of 25% and less than 0.02%, because polyaniline precipitated almost without solubilization or dispersion.

### Reference Example 1

An emulsion composition (1) containing nonvolatile matters in an amount of 26% was prepared by emulsion polymerization reaction in a similar manner to Example 1, except that a liquid mixture consisting of 20 parts of styrene, 10 parts of butyl acrylate, and 10 parts of acrylic acid was placed in a dropping funnel.

### Comparative Example 2

Ten parts of 12N hydrochloric acid and 4.65 parts of aniline were dissolved in 150 parts of the emulsion composition (1) obtained in Reference Example 1 above. Separately, an aqueous oxidizer solution of 11.4 parts of ammonium persulfate in 100 parts of ion-exchange water was prepared. The two solutions were cooled to 5° C. respectively and then mixed and stirred for 8 hours allowing the reaction between them, to give a comparative polyaniline-containing composition (2) containing nonvolatile matters and polyaniline respectively at concentrations of 23% and 1.3%. The reaction rate of the oxidative polymerization of aniline in the reaction was 80%.

### Reference Example 2

To a solution of 10 parts of p-toluenesulfonic acid in 150 parts of ion-exchange water, added were 1.5 parts of sulfuric acid and 2.5 parts of aniline, and the mixture was cooled to 0° C. Separately, a solution of 5.5 parts of ammonium persulfate in 50 parts of ion-exchange water was previously cooled to 0° C., and added dropwise into the aniline-containing solution above over 15 minutes. The mixture was stirred at 0° C. for 20 hours, and then, concentrated by ultrafiltration, to give a polyaniline solution containing nonvolatile matters and polyaniline respectively at concentrations of 38% and 5.0%.

Further, 100 parts of the polyaniline solution thus obtained and 100 parts of the emulsion composition (1) obtained in Reference Example 1 were mixed, to give a polyaniline-containing composition (3) (comparative composition) containing nonvolatile matters and polyaniline respectively at concentrations of 32% and 2.5%.

[Evaluation Methods]

Properties of the polyaniline-containing compositions (1) to (3) obtained Examples 1 to 3 and comparative polyaniline-containing compositions (1) to (3) obtained in Comparative Examples 1 to 3 were determined by the methods described below. The results are summarized in Table 1.

(a) Surface Resistance

Each of the sample polyaniline-containing compositions was coated on a glass plate to a thickness of about 2 μm with a bar coater and dried at 120° C. for 30 minutes, to form a coated film having a thickness of 2 μm, and the surface resistance of each coated film was determined according to JIS K6911 by using an electrical resistance meter.

(b) Water Resistence

Each of the sample polyaniline-containing compositions was coated on a chromate-finished aluminum substrate to a thickness of about 2 μm with a bar coater and dried at 120° C. for 30 minutes, to form a coated film having a thickness of 2 μm. The test substrate carrying the coated film was immersed in ion-exchange water at 25° C.±3 for 3 days, and then the appearance was evaluated by visual observation according to the following criteria.

◯ . . . No change

Δ . . . Partial swelling

x . . . Some breakdown observable in coated film

(c) Pencil Hardness

Each of the sample polyaniline-containing compositions was coated on a chromate-finished aluminum substrate to a thickness of about 2 μm with a bar coater and dried at 120° C. for 30 minutes, to form a coated film having a thickness of 2 μm, and the pencil hardness of the coated film was determined according to JIS K6911.

TABLE 1

| | | | Water | Pencil |
|---|---|---|---|---|
| | | Surface | resis- | hard- |
| | | resistance | tence | ness |
| Example 1 | Polyaniline-containing | 1.0 × 10⁶ | ◯ | H |
| | composition (1) | | | |
| Example 2 | Polyaniline-containing | 3.5 × 10⁸ | ◯ | H |
| | composition (2) | | | |
| Example 3 | Polyaniline-containing | 3.0 × 10⁶ | ◯ | H |
| | composition (3) | | | |
| Comparative | Comparative polyaniline- | 1.0 × 10¹² | ◯ | H |
| Example 1 | containing composition | | | |
| | (1) | | | |
| Comparative | Comparative polyaniline- | 6.5 × 10⁹ | Δ | 2B |
| Example 2 | containing composition | | | |
| | (2) | | | |
| Comparative | Comparative polyaniline- | 5.3 × 10⁶ | X | B |
| Example 3 | containing composition | | | |
| | (3) | | | |

As apparent from Table 1 above, the polyaniline-containing compositions obtained in Examples 1 to 3, in which polyaniline was dispersed uniformly, gave a uniform coated film, and the coated film formed was higher in conductivity and superior in water resistence, strength, and flexibility.

In contrast, the polyaniline-containing composition of Comparative Example 1 was almost non-conductive, because it had a lower concentration of polyaniline and was not doped. In addition, the polyaniline-containing composition of Comparative Example 2, which contained polyaniline lower in the degree of polymerization that is unevenly dispersed, gave a coated film lower in conductivity and also insufficient in the water resistence, the strength, and the flexibility of the coated film, because of the aniline monomer remaining in a greater amount. Further, the coated film of Comparative Example 3 was favorable in conductivity because of the dopant used in a larger amount, but insufficient in the water resistence, the strength, and the flexibility.

### INDUSTRIAL APPLICABILITY

As described above, the polyaniline-containing composition according to the present invention, which includes a polyaniline uniformly dispersed, gives a high-performance coated film higher in conductivity and superior in water resistence as well as strength and flexibility as it is coated.

1. A polyaniline-containing composition, characterized by comprising a polyaniline and an emulsion polymer, wherein the emulsion polymer including a vinylpyrrolidone and an acid group-containing monomer as constituent monomers and as essential components.

2. The polyaniline-containing composition according to claim 1, wherein the content of the vinylpyrrolidone is in the range of 10 to 70% by mass in the total constituent monomers for the emulsion polymer.

3. The polyaniline-containing composition according to claim 1, wherein the content of the acid group-containing monomer is in the range of 0.1 to 40% by mass in the total constituent monomers for the emulsion polymer.

4. The polyaniline-containing composition according to claim 1, wherein the polyaniline is an emeraldine-type polyaniline.

5. The polyaniline-containing composition according to claim 2, wherein the content of the acid group-containing monomer is in the range of 0.1 to 40% by mass in the total constituent monomers for the emulsion polymer.

6. The polyaniline-containing composition according to claim 2, wherein the polyaniline is an emeraldine-type polyaniline.

7. The polyaniline-containing composition according to claim 3, wherein the polyaniline is an emeraldine-type polyaniline.

8. The polyaniline-containing composition according to claim 5, wherein the polyaniline is an emeraldine-type polyaniline.
